(19) United States
(12) Patent Application Publication
(10) Pub. No.: US 2024/0242364 A1
(43) Pub. Date: Jul. 18, 2024

(54) IMAGE SIGNAL PROCESSOR

(71) Applicant: SK hynix Inc., Icheon-si Gyeonggi-do (KR)

(72) Inventor: Ji Hee HAN, Icheon-si Gyeonggi-do (KR)

(73) Assignee: SK hynix Inc., Icheon-si Gyeonggi-do (KR)

(21) Appl. No.: 18/396,204

(22) Filed: Dec. 26, 2023

(30) Foreign Application Priority Data
Jan. 12, 2023 (KR) 10-2023-0004845

(51) Int. Cl. G06T 7/50; G06T 7/80; G06V 10/74

(52) U.S. Cl. CPC G06T 7/50; G06T 7/80; G06V 10/761; G06T 2207/20228

(57) ABSTRACT

An image signal processor includes a calibration interpolation unit configured to generate interpolation calibration information for a target pixel using calibration information of at least one grid pixel adjacent to the target pixel. The image signal processor also includes a depth data correction unit configured to generate corrected depth data by correcting target depth data of the target pixel based on the interpolation calibration information.

### CROSS-REFERENCE TO RELATED APPLICATION

This patent document claims the priority and benefits of Korean patent application No. 10-2023-0004845, filed on Jan. 12, 2023, in the Korean Intellectual Property Office, the disclosure of which is incorporated herein by reference in its entirety as part of the disclosure of this patent document.

### TECHNICAL FIELD

The technology and implementations disclosed in this patent document generally relate to an image signal processor capable of processing an image of a scene.

### BACKGROUND

An image sensing device is a device for capturing optical images by converting light into electrical signals using a photosensitive semiconductor material which reacts to light. With the development of automotive, medical, computer, and communication industries, the demand for high-performance image sensing devices is increasing in various fields such as smart phones, digital cameras, game machines, IoT (Internet of Things), robots, security cameras, and medical micro cameras.

The image sensing device may be used to obtain a color image of a scene or a depth image of a scene. The image sensing device detects incident light through a lens module to secure a wider field of view (FOV), such that various distortions may occur due to characteristics of the lens module.

Because such distortion may degrade the quality of a color image or the quality of a depth image, a process for removing noise caused by such distortion from data obtained from the image sensing device may be of importance to improvement in image quality.

### SUMMARY

Various embodiments of the disclosed technology may relate to an image signal processor for generating an image less affected by distortion of a lens module.

In accordance with an embodiment of the disclosed technology, an image signal processor may include: a calibration interpolation unit configured to generate interpolation calibration information for a target pixel using calibration information of at least one grid pixel adjacent to the target pixel; and a depth data correction unit configured to generate corrected depth data by correcting target depth data of the target pixel based on the interpolation calibration information.

In accordance with an embodiment of the disclosed technology, an image signal processor may include: a calibration information storage configured to store calibration information of a plurality of grid pixels and reference calibration information; and a depth data correction unit configured to correct target depth data of the target pixel according to where the target pixel is located based on either interpolation calibration information generated according to calibration information of the plurality of grid pixels or the reference calibration information, and configured to generate corrected depth data based on the corrected target depth data.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an imaging device based on some implementations of the disclosed technology.

FIG. 2 is a schematic diagram illustrating an example of a method for obtaining calibration information based on some implementations of the disclosed technology.

FIG. 3 is a schematic diagram illustrating an example of grid pixels capable of generating calibration information based on some implementations of the disclosed technology.

FIG. 4 is a graph illustrating an example of a method for obtaining calibration information for grid pixels based on some implementations of the disclosed technology.

FIG. 5 is a flowchart illustrating an example of a method for correcting depth data based on some implementations of the disclosed technology.

FIG. 6 is a schematic diagram illustrating an example of operation S20 shown in FIG. 5 based on some implementations of the disclosed technology.

FIG. 7 is a schematic diagram illustrating an example of operation S60 shown in FIG. 5 based on some implementations of the disclosed technology.

FIG. 8 is a schematic diagram illustrating an example of operation S70 shown in FIG. 5 based on some implementations of the disclosed technology.

### DETAILED DESCRIPTION

This patent document provides implementations and examples of an image signal processor capable of processing an image of a scene that may be used in configurations to substantially address one or more technical or engineering issues and to mitigate limitations or disadvantages encountered in some other image signal processors. Some implementations of the disclosed technology relate to an image signal processor for generating an image less affected by distortion of a lens module. The disclosed technology provides various implementations of an image signal processor that can remove noise caused by distortion of the lens module from data obtained from the image sensing device using a minimum of resources.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

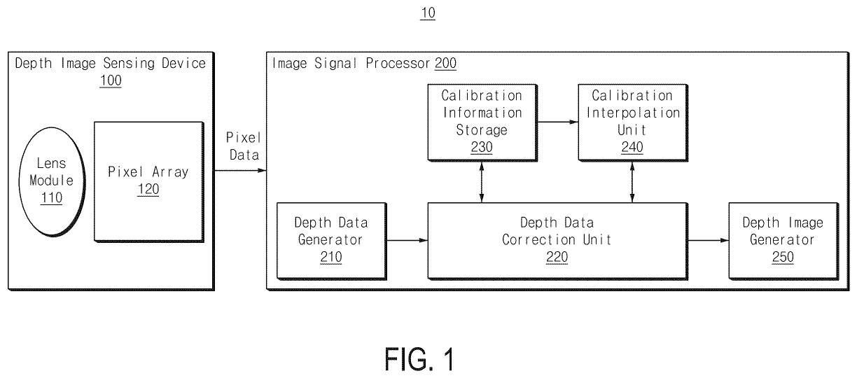

FIG. 1 is a block diagram illustrating an example of an imaging device 10 based on some implementations of the disclosed technology.

Referring to FIG. 1, the imaging device 10 serving as a device for acquiring a depth image of a scene may include a depth image sensing device 100 and an image signal processor 200. The depth image may be an image representing a sense of distance for each pixel for the scene. That is, a user can visually check the distance to the scene for each pixel through the depth image.

The depth image sensing device 100 may create pixel data required to acquire depth data for a scene using at least one depth sensing technology. Here, the depth data may be information that is a basis for creating a depth image, and the type of depth data may vary depending on a depth sensing technology to be used by the depth image sensing device 100.

According to one embodiment, the depth image sensing device 100 may use a stereoscopic method for comparing two images captured by two cameras having parallel optical axes. In this case, depth data may be a disparity indicating a difference in position between subject images (i.e., images of a captured target object) commonly displayed on the two images.

According to another embodiment, the depth image sensing device 100 may use a direct TOF (Time of Flight) method that directly measures a time difference between an irradiation time point of pulse light emitted to a scene and a reception time point (i.e., an incidence time point) of the pulse light reflected from the scene. In this case, the depth data may represent a time difference between the irradiation time point of the pulse light and the reception time point of the pulse light reflected from the scene.

According to still another embodiment, the depth image sensing device 100 may use an indirect TOF (Time of Flight) method that calculates a phase difference between modulated light emitted to a scene and light reflected from the scene. In this case, the depth data may represent a phase difference between the modulated light and the reflected light.

The depth image sensing device 100 may include a lens module 110 and a pixel array 120.

The lens module 110 may collect incident light reflected from a scene, and may allow the collected light to be focused onto pixels of the pixel array 120. For example, the lens module 110 may include a focusing lens having a surface formed of glass or plastic or another cylindrical optical element having a surface formed of glass or plastic. The lens module 110 may include a plurality of lenses that is arranged to be focused upon an optical axis.

Because the pixel array 120 has a much smaller area than a field of view (FOV) required for the depth image sensing device 100, the lens module 110 has a predetermined curvature to converge (condense) light corresponding to the FOV.

When incident light received from a flat plane passes through the lens module 110 according to the curvature characteristics of the lens module 110, a focal plane of the incident light has a predetermined curvature, so that there may occur a field curvature phenomenon in which some pixels (near the center of the scene) are in focus and other pixels (near the edge of the scene) are out of focus.

In addition, due to light refraction caused by the lens module 110, there may occur the vignetting phenomenon in which an image of the scene becomes darker as it approaches the edge of the scene.

The pixel array 120 may generate pixel data by sensing light incident through the lens module 110. To this end, the depth image sensing device 100 may include a control circuit (not shown) for driving the pixel array 120 and a readout circuit (not shown) for generating digital pixel data by processing an electrical signal output from the pixel array 120.

The pixel array 120 may include a plurality of pixels consecutively arranged in a two-dimensional (2D) matrix structure. In some implementations, the plurality of pixels may be arranged in a matrix array including a plurality of rows and a plurality of columns.

Pixel data generated by each of the plurality of pixels may be converted into depth data by the image signal processor 200, and the type of pixel data may vary depending on the depth sensing technology to be used by the depth image sensing device 100.

According to one embodiment, when the depth image sensing device 100 uses the stereoscopic method, pixel data may refer to data constituting two images having a predetermined disparity therebetween.

According to another embodiment, when the depth image sensing device 100 uses the direct TOF method, the pixel data may refer to a time count value from an irradiation time point of the pulse light emitted to a scene to an incidence time point (reception time point) of the pulse light reflected from the scene.

According to still another embodiment, when the depth image sensing device 100 uses the indirect TOF method, pixel data may refer to data constituting two images having a predetermined phase difference therebetween.

The image signal processor 200 may generate a depth image by performing at least one image signal processing operation on pixel data. The image signal processor 200 may remove lens distortion generated by the lens module 110 from pixel data generated by the depth image sensing device 100.

The image signal processor 200 may include a depth data generator 210, a depth data correction unit 220, a calibration information storage 230, a calibration interpolation unit 240, and a depth image generator 250.

The depth data generator 210 may generate depth data using pixel data.

According to one embodiment, when the depth image sensing device 100 uses the stereoscopic method, the depth data generator 210 may calculate a disparity between two images using pixel data.

According to another embodiment, when the depth image sensing device 100 uses the direct TOF method, the depth data generator 210 may calculate a time difference between an irradiation time point of the pulse light and an incidence time point of the pulse light reflected from the scene using pixel data.

According to still another embodiment, when the depth image sensing device 100 uses the indirect TOF method, the depth data generator 210 may calculate a phase difference between the modulated light and the reflected light using pixel data.

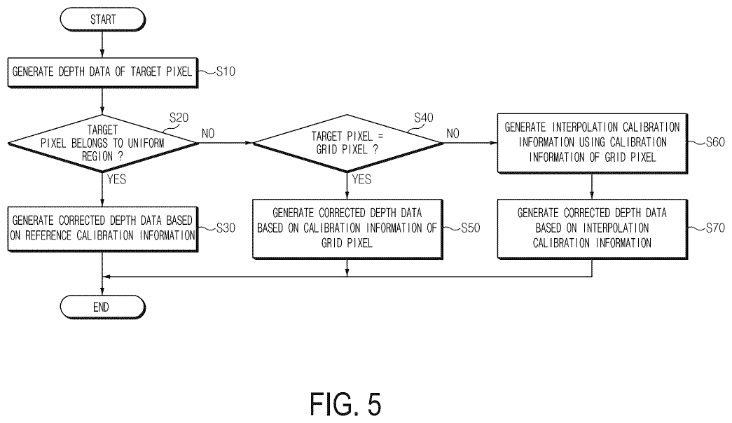

The depth data correction unit 220 may determine a correction method for pixel data based on the position (e.g., coordinates) of a pixel corresponding to depth data, and may perform correction on the pixel data according to the determined correction method. When the pixel data is corrected, the depth data correction unit 220 may perform such correction by referring to and/or controlling the calibration information storage 230 and the calibration interpolation unit 240. A more detailed operation of the depth data correction unit 220 will be described later with reference to FIG. 5.

The calibration information storage 230 may store calibration information of each of the pixels included in the pixel array 120. According to one embodiment, the calibration information storage 230 may store only calibration information of some pixels selected from among pixels included in the pixel array 120 without storing calibration information of all pixels included in the pixel array 120. In addition, the calibration information storage 230 may store calibration information obtained by processing calibration information of some pixels selected from among pixels included in the pixel array 120.

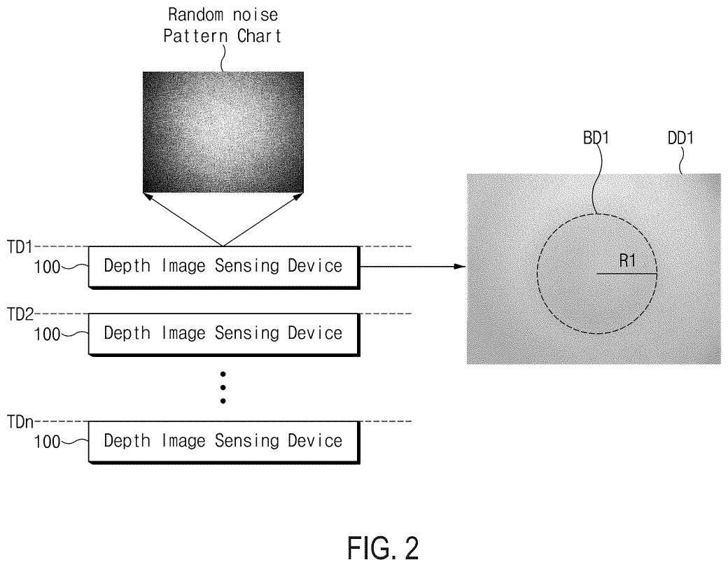

Calibration information is information used for correction of pixel data, and may be information indicating a relationship between depth data and a test distance in a corresponding pixel. For example, the depth data and the test distance may have a linear relationship therebetween, and the calibration information may include slopes and intercepts that may represent the linear relationship. A process for obtaining calibration information will be described later with reference to FIGS. 2 to 4.

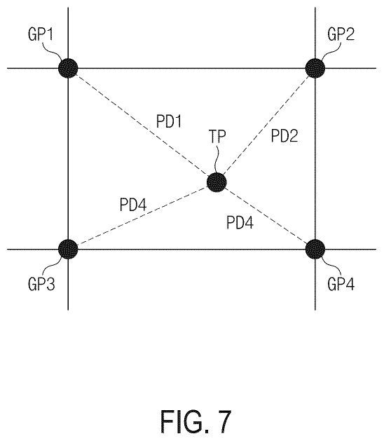

The calibration interpolation unit 240 may perform interpolation using calibration information of at least one pixel by referring to the calibration information storage 230 upon receiving a request of the depth data correction unit 220, and may create interpolation calibration information. A more detailed operation of the calibration interpolation unit 240 will be described later with reference to FIG. 7.

The depth image generator 250 may create a depth image using corrected depth data provided from the depth data correction unit 220. The image signal processor 200 may be a computing device mounted on a chip independent of a chip on which the depth image sensing device 100 is mounted. The chip on which the depth image sensing device 100 is mounted and the chip on which the image signal processor 200 is mounted may communicate with each other through a predetermined interface. According to one embodiment, the chip on which the depth image sensing device 100 is mounted and the chip on which the image signal processor 200 is mounted may be implemented in one package, for example, a multi-chip package (MCP), but the scope of the present invention is not limited thereto. The chip on which the image signal processor 200 is mounted may include a memory device that the image signal processor 200 can access, and the memory device may store pixel data and/or depth image. Also, the memory device may store instructions for executing components 210 to 250 of the image signal processor 200 implemented in hardware, software, or a combination thereof. Meanwhile, the image signal processor 200 may generate the processed image data IDATA_P by performing at least one image signal processing on the image data IDATA received from the depth image sensing device 100, and may generate the processed image data IDATA_P. The image signal processor 200 may store the processed image data IDATA_P in the memory device or output the processed image data IDATA_P to an external device (e.g, an application processor, a flash memory, a display, etc.).

According to one embodiment, when the depth image sensing device 100 uses the stereoscopic method, the depth image generator 250 may calculate the distance from the scene using a disparity between images.

According to another embodiment, when the depth image sensing device 100 uses the direct TOF method, the depth image generator 250 may calculate the distance from the scene using the time difference between the irradiation time point of the pulse light and the incidence time point of the reflected pulse light.

According to still another embodiment, when the depth image sensing device 100 uses the indirect TOF method, the depth image generator 250 can calculate the distance from the scene using a phase difference between the modulated light and the reflected light.

FIG. 2 is a schematic diagram illustrating an example of a method for obtaining calibration information based on some implementations of the disclosed technology.

Referring to FIG. 2, calibration information for the depth image sensing device 100 may be obtained from a test process of the depth image sensing device 100, and the obtained calibration information may be stored in the calibration information storage 230.

According to another embodiment, the calibration information for the depth image sensing device 100 may be stored in a storage (not shown) included in the depth image sensing device 100, and the image signal processor 200 may also perform correction of the depth data by referring to the storage included in the depth image sensing device 100.

The depth image sensing device 100 may create pixel data by photographing a random noise pattern chart arranged on a front surface to be perpendicular to the optical axis of the lens module 110, and a test device (not shown) may create depth data using the created pixel data. Because the random noise pattern chart is formed in a flat shape, the depth data for the random noise pattern chart arranged to be perpendicular to the optical axis of the lens module 110 must ideally have the same value regardless of the position of each pixel. However, as described above, lens distortion may occur due to characteristics of the lens module 110, and the depth data may vary depending on the position of pixels due to such lens distortion.

As shown in FIG. 2, in first depth data DD1 obtained from the depth image sensing device 100 located at a first test distance TD1, it can be seen that the depth data changes with a predetermined pattern outside of the first boundary BD1 whereas there is almost no change in the depth data inside of the first boundary BD1. The first boundary BD1 may have a circular shape (the lens module 110 may be modeled as one thick lens and thus a pattern corresponding to the circular shape may appear) or a figure shape similar to the circular shape according to characteristics of the lens module 110. However, in some implementations of the disclosed technology, it is assumed that the lens module 110 is formed in a circular shape for convenience of description. In this case, the first boundary BD1 may have a circular shape having a first radius (R1).

The first boundary BD1 may be determined by positions of pixels in which a deviation from depth data of a pixel (i.e., a central pixel) located at the center of a frame (or scene) is within a predetermined threshold value.

While the random noise pattern chart is fixed, the distance between the depth image sensing device 100 and the random noise pattern chart may be changed from the second test distance TD2 to the n-th test distance TDn (where ‘n’ is an integer of 3 or greater) such that each of the second depth data to the N-th depth data can be obtained. Here, ‘n’ may be determined experimentally as an appropriate value in consideration of performance of the test device, accuracy of calibration, test speed, and the like. Also, each of the test distances (TD1˜TDn) may be determined in consideration of a distance measurable range of the depth image sensing device 100 (e.g., a distance measurable range is included in the test distance range).

The test device may obtain first to n-th depth data at the test distances (TD1˜TDn), respectively. Also, the test device may obtain first to n-th radii for the first to n-th depth data, respectively.

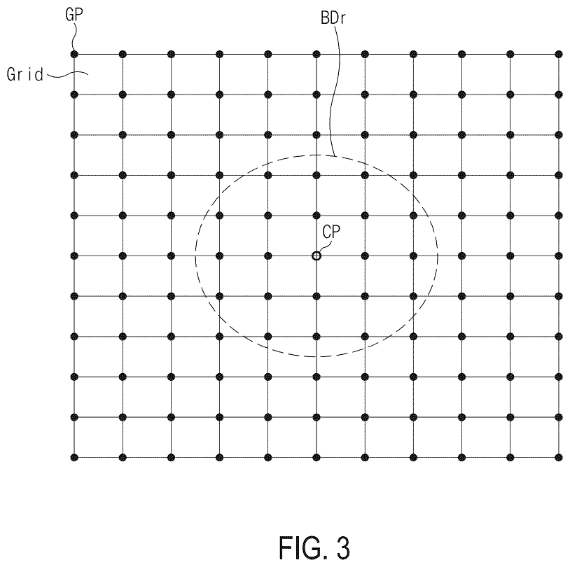

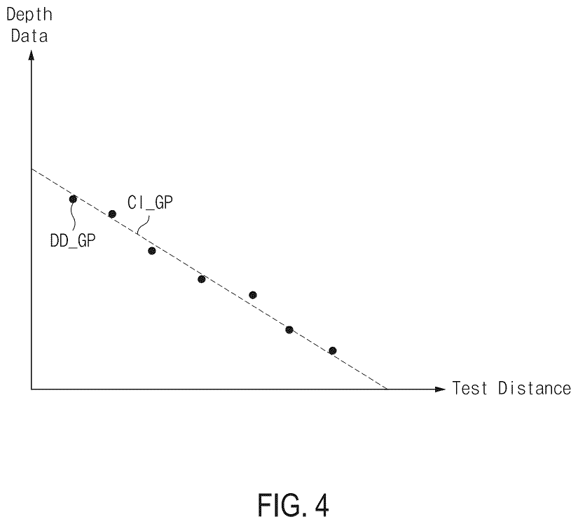

FIG. 3 is a schematic diagram illustrating an example of grid pixels capable of generating calibration information based on some implementations of the disclosed technology. FIG. 4 is a graph illustrating an example of a method for obtaining calibration information for grid pixels based on some implementations of the disclosed technology.

Referring to FIG. 3, the test device may divide a pixel array into a plurality of grids, and may calculate calibration information for grid pixels located at vertices of each grid. The grid pixels adjacent in a row direction or a column direction may have locations spaced apart from each other by a distance of pixels corresponding to a predetermined offset.

In the example of FIG. 3, an example case in which a pixel array is divided into 100 grids of 10×10 is illustrated, but this example is disclosed only for convenience of description, and the number of grids and the size of each grid may vary depending on requirements (e.g., required performance) of the image signal processor 200.

Each grid may be formed in a quadrangular shape, and a grid pixel (GP) may be located at each vertex of the grid. Also, a pixel located at the center of the frame from among the grid pixels (GP) may be defined as a central pixel CP.

Referring to FIG. 4, depth data (DD_GP) of the grid pixel (GP) may be obtained from each of first to seventh depth data over a total of seven times. In the graph in which the test distance is set to an X-axis and the depth data is set to a Y-axis, depth data (DD_GP) of the grid pixel (GP) obtained from each of the first to seventh depth data may be displayed and approximated as a single straight line. The straight line may refer to calibration information (CI_GP) of the grid pixel (GP), and the calibration information (CI_GP) of the grid pixel (GP) may include slopes and intercepts capable of defining this straight line.

Although only calibration information (CI_GP) for one grid pixel (GP) is shown in FIG. 4 for convenience of description, calibration information for a plurality of grid pixels (GP) (including the central pixel CP) shown in FIG. 3 may be generated and stored in the calibration information storage 230.

According to one embodiment, the test device may determine a reference boundary (BDr), and may determine reference calibration information for grid pixels belonging to the inside of the reference boundary (BDr), so that only reference calibration information for the grid pixels belonging to the inside of the reference boundary (BDr) can be stored in the calibration information storage 230. Even in this case, calibration information for each of grid pixels not belonging to the inside of the reference boundary (BDr) may be stored in the calibration information storage 230.

The reference boundary (BDr) may be determined as a boundary having the largest radius among the first to n-th boundaries of the first to n-th depth data, but the scope of the disclosed technology is not limited thereto. Alternatively, the reference boundary (BDr) may also be determined as a boundary having the smallest radius or a boundary having an average radius of the first to n-th radii.

The reference calibration information may be calibration information of the central pixel CP. According to another embodiment, the reference calibration information may correspond to an average value of calibration information of grid pixels belonging to the inside of the reference boundary (BDr). In this case, the average value of the calibration information may include an average value of the slopes constituting the calibration information, and an average value of intercepts constituting the calibration information.

Because only the reference calibration information for the grid pixels belonging to the inside of the reference boundary (BDr) is stored in the calibration information storage 230, the storage capacity required for the calibration information storage 230 may be significantly reduced, and the load required for the operation of the calibration interpolation unit 240 may also be reduced, thereby improving the operation speed of the image signal processor 200.

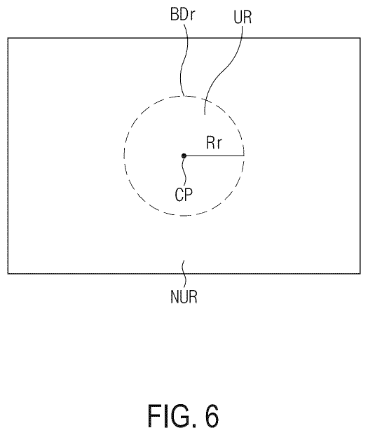

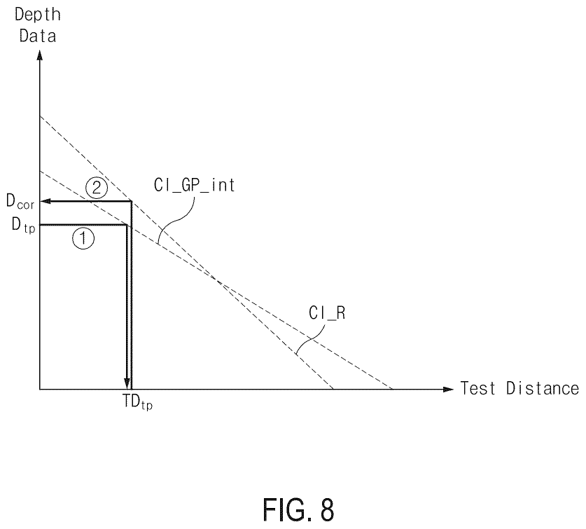

FIG. 5 is a flowchart illustrating an example of a method for correcting depth data based on some implementations of the disclosed technology. FIG. 6 is a schematic diagram illustrating an example of operation S20 shown in FIG. 5 based on some implementations of the disclosed technology. FIG. 7 is a schematic diagram illustrating an example of operation S60 shown in FIG. 5 based on some implementations of the disclosed technology. FIG. 8 is a schematic diagram illustrating an example of operation S70 shown in FIG. 5 based on some implementations of the disclosed technology.

Referring to FIG. 5, depth data correction by the image signal processor 200 may be performed for each pixel (i.e., on a pixel basis), and a pixel to be corrected will hereinafter be referred to as a target pixel.

The depth data generator 210 may receive pixel data of a target pixel from the depth image sensing device 100, and may create depth data (i.e., target depth data) of the target pixel using the received pixel data of the target pixel (S10).

The depth data correction unit 220 may determine whether the position of a target pixel corresponding to depth data to be processed belongs to a uniform region (S20).

In FIG. 6, a region corresponding to the inside of the reference boundary (BDr) within a frame will hereinafter be referred to as a uniform region (UR), and a region corresponding to the outside of the reference boundary (BDr) will hereinafter be referred to as a non-uniform region (NUR). As described above, the reference boundary (BDr) may be determined by the test device and stored in the depth data correction unit 220. In FIG. 6, the reference boundary (BDr) is illustrated as a circular shape having a reference radius (Rr).

The uniform region (UR) may be a continuous region corresponding to a set of pixels in which the deviation of depth data from the central pixel (CP) is equal to or less than a predetermined threshold value, and the non-uniform region (NUR) may be a region other than the uniform region (UR).

When the position of the target pixel belongs to the uniform region UR (i.e., Yes in S20), the depth data correction unit 220 may create corrected depth data by correcting the target depth data based on the reference calibration information stored in the calibration information storage 230 (S30). Because the methods of creating corrected depth data in operations S30, S50, and S70 are substantially identical to each other, operation S30 will be described later with reference to FIG. 8 by referring to the description of operation S70.

When the position of the target pixel does not belong to the uniform region UR (i.e., No in S20), that is, when the position of the target pixel belongs to the non-uniform region NUR, the depth data correction unit 220 may determine whether the position of the target pixel corresponds to the position of the grid pixel (S40).

If the position of the target pixel corresponds to the position of the grid pixel (i.e., Yes in S40), the depth data correction unit 220 may create corrected depth data by correcting the target depth data based on the grid-pixel calibration information stored in the calibration information storage 230 (S50). Because the methods of creating corrected depth data in operations S30, S50, and S70 are substantially identical to each other, operation S50 will be described later with reference to FIG. 8 by referring to the description of operation S70.

If the position of the target pixel does not correspond to the position of the grid pixel (i.e., No in S40), the depth data correction unit 220 may obtain interpolation calibration information for the target pixel by controlling the calibration interpolation unit 240.

If the target pixel belongs to the non-uniform region (NUR) and does not correspond to the grid pixel, calibration information for the target pixel is not stored in the calibration information storage 230 so that the calibration information storage 230 cannot directly provide such calibration information of the target pixel.

Accordingly, the calibration interpolation unit 240 may perform interpolation using calibration information of at least one grid pixel adjacent to the target pixel, and may create interpolation calibration information as the result of interpolation (S60). According to one embodiment, the calibration interpolation unit 240 may create interpolation calibration information by interpolating the calibration information of at least one grid pixel using a distance between the target pixel and at least one grid pixel as an interpolation weight.

In FIG. 7, first to fourth grid pixels (GP1˜GP4) adjacent to the target pixel (TP) are illustrated. That is, the grid pixels adjacent to the target pixel (TP) may refer to grid pixels arranged at four vertices of the grid to which the target pixel (TP) belongs, but the scope of the disclosed technology is not limited thereto. Alternatively, the grid pixels adjacent to the target pixel (TP) may also refer to an arbitrary number of grid pixels located closest to the target pixel (TP).

The calibration interpolation unit 240 may calculate first to fourth pixel distances (PD1˜PD4) that are distances between the target pixel (TP) and each of the first to fourth grid pixels (GP1˜GP4). In addition, the calibration interpolation unit 240 may determine a reciprocal of each of the first to fourth pixel distances (PD1˜PD4) as an interpolation weight for each of the first to fourth grid pixels (GP1˜GP4).

The calibration interpolation unit 240 may calculate a first value obtained by multiplying the calibration information for the first grid pixel (GP1) by a reciprocal of the first pixel distance (PD1), may calculate a second value obtained by multiplying the calibration information for the second grid pixel (GP2) by a reciprocal of the second pixel distance (PD2), may calculate a third value obtained by multiplying the calibration information for the third grid pixel (GP3) by a reciprocal of the third pixel distance (PD3), and may calculate a fourth value obtained by multiplying the calibration information for the fourth grid pixel (GP4) by a reciprocal of the fourth pixel distance (PD4). Thereafter, the calibration interpolation unit 240 may create interpolation calibration information indicating calibration information of the target pixel (TP) by averaging the first to fourth values. Such calculation may be performed independently for each of the slope and intercept of the calibration information, and thus the interpolation calibration information may include an average slope and an average intercept.

When the interpolation calibration information is completely created by the calibration interpolation unit 240, the depth data correction unit 220 may create corrected depth data by correcting target depth data based on the interpolation calibration information (S70).

In FIG. 8, a straight line according to interpolation calibration information (CI_GP_int) and a straight line according to reference calibration information (CI_R) are illustrated.

The depth data correction unit 220 may calculate a test distance (TDₜₚ) corresponding to target depth data (Dₜₚ) by substituting the target depth data (Dₜₚ) into an equation of the straight line corresponding to the interpolation calibration information (CI_GP_int). Next, the depth data correction unit 220 may calculate correction depth data (D_{cor}) corresponding to the test distance (TDₜₚ) by substituting the test distance (TDₜₚ) into an equation of the straight line corresponding to the reference calibration information (CI_R).

The above-described correction process may be represented by the following equation 1 below.

$${D}_{c o r} = I ( CI \_ R ) + \frac{S ( CI \_ R ) ( {D}_{t p} - I ( CI \_ GP \_ int ) )}{S ( CI \_ GP \_ int )} \qquad [ Equation 1 ]$$

In Equation 1, S(CI_GP_int) may denote a slope (gradient) of the interpolation calibration information (CI_GP_int), and I(CI_GP_int) may denote an intercept of the interpolation calibration information (CI_GP_int). In addition, S(CI_R) may denote a slope (gradient) of the reference calibration information (CI_R), and I(CI_R) may denote an intercept of the reference calibration information (CI_R).

Because the target depth data (Dₜₚ) corresponds to an inaccurate value due to lens distortion, the depth data correction unit 220 may calculate the test distance (TDₜₚ) corresponding to the target depth data (Dₜₚ) using the interpolation calibration information (CI_GP_int) (see Operation \textcircled{1} shown in FIG. 8), and may calculate the correction depth data (D_{cor}) corresponding to the test distance (TDₜₚ) using the reference calibration information (CI_R) based on the calculated test distance (TDₜₚ) (see Operation \textcircled{2} shown in FIG. 8), thereby obtaining depth data from which the influence of lens distortion has been removed.

Even in operation S50, the correction depth data (D_{cor}) can be created in the same manner as in Equation 1, but S(CI_GP_int) may be replaced with the slope included in the calibration information of the grid pixel and I(CI_GP_int) may be replaced with the intercept included in the calibration information of the grid pixel.

In addition, even in operation S30, the correction depth data (D_{cor}) can be created in the same manner as in Equation 1, but S(CI_GP_int) may be replaced with the slope included in the reference calibration information and I(CI_GP_int) may be replaced with the intercept included in the reference calibration information.

As is apparent from the above description, the image signal processor based on some implementations of the disclosed technology may remove noise caused by distortion of the lens module from data obtained from the image sensing device using a minimum of resources.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An image signal processor comprising:
a calibration interpolation unit configured to generate interpolation calibration information for a target pixel using calibration information of at least one grid pixel adjacent to the target pixel; and
a depth data correction unit configured to generate corrected depth data by correcting target depth data of the target pixel based on the interpolation calibration information.

2. The image signal processor according to claim 1, wherein the at least one grid pixel includes:
a pixel corresponding to each vertex of a grid to which the target pixel belongs.

3. The image signal processor according to claim 2, wherein:
the interpolation calibration information corresponds to a result of performing interpolation on the calibration information of the at least one grid pixel based on a distance between the target pixel and each of the grid pixels.

4. The image signal processor according to claim 1, wherein:
the calibration information includes a slope and an intercept that indicate a relationship between depth data and a test distance in the grid pixel.

5. The image signal processor according to claim 1, wherein the depth data correction unit is configured to generate, when the target pixel belongs to a uniform region, the corrected depth data by correcting the target depth data based on reference calibration information.

6. The image signal processor according to claim 5, wherein:
the reference calibration information refers to calibration information of a central pixel.

7. The image signal processor according to claim 5, wherein:
the reference calibration information refers to average calibration information of grid pixels belonging to the uniform region.

8. The image signal processor according to claim 5, wherein:
the uniform region is formed in a circular shape having a predetermined radius.

9. The image signal processor according to claim 1, wherein the depth data correction unit is configured to:
calculate a test distance corresponding to the target depth data using the interpolation calibration information; and
calculate the corrected depth data corresponding to the calculated test distance using the reference calibration information.

10. The image signal processor according to claim 1, further comprising:
a calibration information storage configured to store calibration information of a plurality of grid pixels including the at least one grid pixel.

11. The image signal processor according to claim 10, wherein:
among the plurality of grid pixels, grid pixels adjacent to each other in a row direction or a column direction are spaced apart from each other by a distance between pixels corresponding to a predetermined offset.

12. The image signal processor according to claim 1, wherein:
the target depth data refers to a disparity, a time difference between an irradiation time point of pulse light and an incidence time point of reflected pulse light, or a phase difference between modulated light and reflected light.

13. An image signal processor comprising:
a calibration information storage configured to store calibration information of a plurality of grid pixels and reference calibration information; and
a depth data correction unit configured to correct target depth data of the target pixel according to where the target pixel is located based on either interpolation calibration information generated according to calibration information of the plurality of grid pixels or the reference calibration information, and configured to generate corrected depth data based on the corrected target depth data.
